(19) United States
(12) Patent Application Publication
(10) Pub. No.: US 2026/0228442 A1
(43) Pub. Date: Aug. 6, 2026

(54) END-OF-SPEECH DETECTION FOR CHATBOT INTERACTIONS

(71) Applicant: PlanetArt, LLC, Calabasas, CA (US)

(72) Inventor: Erik Malkemus, Reseda, CA (US)

(21) Appl. No.: 19/042,758

(22) Filed: Jan. 31, 2025

(51) Int. Cl. G06F 40/35; G10L 15/26

(52) U.S. Cl. CPC G06F 40/35; G10L 15/26

(57) ABSTRACT

Methods, apparatus, and processor-readable storage media for end-of-speech detection for chatbot interactions are provided herein. An example method includes converting at least a portion of a speech message into converted text, where the speech message is provided by a user as part of a human-computer conversation. The method includes performing a contextual analysis on the converted text to determine whether the user is finished providing the speech message, where the contextual analysis comprises processing, using a first machine learning model instance, the converted text corresponding to the speech message and contextual text corresponding to one or more previous speech messages in the human-computer conversation. The method also includes generating, based at least in part on a result of the contextual analysis, a response to the speech message, where the response is generated by a second machine learning model instance.

### BACKGROUND

The present invention relates generally to artificial intelligence, and, more specifically, to using language models in customer service interactions. Organizations are increasingly relying on tools, such as chatbots, to assist with customer service interactions. Chatbots generally refer to software programs that are designed to simulate conversations with human users. For example, chatbots can be programmed to answer frequently asked questions, to troubleshoot common problems, and/or provide information about products or services.

### SUMMARY

Illustrative embodiments of the disclosure provide techniques for end-of-speech detection for chatbot interactions. An exemplary computer-implemented method includes converting at least a portion of a speech message into converted text, wherein the speech message is provided by a user as part of a human-computer conversation; performing a contextual analysis on the converted text to determine whether the user is finished providing the speech message, wherein the contextual analysis comprises processing, using a first machine learning model instance, the converted text corresponding to the speech message and contextual text corresponding to one or more previous speech messages in the human-computer conversation; and generating, based at least in part on a result of the contextual analysis, a response to the speech message, wherein the response is generated by a second machine learning model instance.

Illustrative embodiments can provide significant advantages relative to conventional techniques. For example, technical problems associated with unnecessary delays or premature terminations in chatbot interactions are mitigated in one or more embodiments by utilizing multiple machine learning models to efficiently determine when a user has finished speaking. Such embodiments can improve the responsiveness and/or accuracy of conversational interactions, thereby facilitating more natural and efficient human-computer interactions.

These and other illustrative embodiments described herein include, without limitation, methods, apparatus, systems, and computer program products comprising processor-readable storage media.

### BRIEF DESCRIPTION OF THE DRAWINGS

FIG. 1 is a block diagram of one possible and non-limiting exemplary system in which the exemplary embodiments may be practiced.

FIG. 2 is a system architecture for end-of-speech detection for chatbot interactions in an illustrative embodiment.

FIG. 3 is an example of a process flow diagram for end-of-speech detection using multiple machine learning models in accordance with an illustrative embodiment.

FIG. 4 is a logic flow diagram for end-of-speech detection in accordance with an illustrative embodiment.

### DETAILED DESCRIPTION

The rise of AI-powered chatbots has played a pivotal role in automating and enhancing human-computer interactions. Speech-enabled chatbots aim to offer a more natural, accessible, and efficient way for users to interact with technology, providing benefits like hands-free convenience and personalized experiences. For businesses, speech-enabled chatbots can increase customer satisfaction, reduce costs and improve efficiency by handling a high volume of user inquiries.

Conventional speech-enabled chatbots often rely on voice activity detection (VAD) mechanisms that use fixed timeouts (e.g., three seconds of silence) to determine when a user has finished speaking. While simple to implement, fixed timeouts can lead to a suboptimal user experience. For example, the user may experience unnecessary delays if the system waits for the entire timeout period even though the user has signaled the end of their input, or the chatbot may prematurely interrupt the user if a short pause is interpreted as the end of input.

The exemplary embodiments herein describe techniques for end-of-speech detection for chatbot interactions. Additional description of these techniques is presented after a system into which the exemplary embodiments may be used is described.

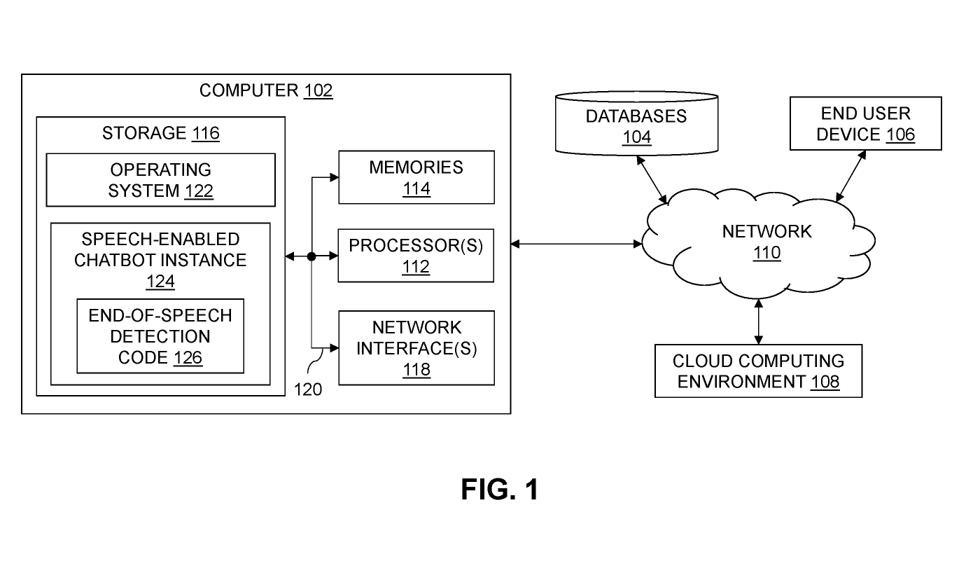

FIG. 1 shows a block diagram of one possible and non-limiting example of a computing environment in which the exemplary embodiments may be practiced. For example, the computing environment depicted in FIG. 1 can be used for executing at least some of the computer code associated with one or more exemplary processes described herein, such as speech-enabled chatbot instance 124 and/or the end-of-speech detection code 126.

The computing environment in FIG. 1 includes, for example, at least one computer 102, one or more databases 104, at least one end user device 106, at least one cloud computing environment 108, and a network 110 (e.g., a wide area network (WAN)). In this context and elsewhere herein, the term “user” is intended to be broadly construed so as to encompass, for example, human, hardware, software, or firmware entities, as well as various combinations of such entities.

The at least one computer 102 includes one or more processors 112, one or more memories 114, storage 116, and one or more network interfaces 118, interconnected through one or more buses 120.

In some embodiments, the computer 102 can be implemented as, for example, a desktop computer, laptop computer, tablet computer, server or other type of computer or device that is capable of, for example, executing one or more applications, accessing one or more networks, and/or communicating with one or more databases, such as databases 104.

Although some embodiments are described herein with reference to a single computer (e.g., computer 102), this is not intended to be limiting, and other implementations are also possible. For example, in at least some embodiments, performance of one or more computer-implemented processes described herein can be distributed among multiple computers, possibly distributed across multiple locations. As another example, computer 102 may be implemented at least partially within a cloud environment, such as the at least one cloud computing environment 108.

The one or more processors 112 can include, for example, one or more central processing units (CPUs), one or more graphics processing unit (GPUs), and/or other accelerators, one or more application-specific integrated circuits (ASICs), one or more microprocessors, one or more microcontrollers, and/or other types of processing circuitry. Also, one or more of the processors 112 can include multiple processor cores, multiple processor threads, and/or be distributed across multiple packages. At least some of the processors 112 may implement one or more cache memories (not explicitly shown in FIG. 1).

The one or more memories 114 can include, for example, volatile memory, such as static random-access memory (SRAM), dynamic random-access memory (DRAM), and/or other types of random-access memory (RAM).

In some embodiments, storage 116 can include non-volatile storage (such as read-only memory (ROM)) and possibly other types of memory (e.g., memory that enables data to be written and/or deleted). Non-limiting examples of storage 116 include hard disk drives (HDDs), solid-state drives (SSDs), optical media, and magnetic disks.

In the FIG. 1 example, storage 116 includes an operating system (OS) 122. The OS 122 can correspond to a propriety OS or a commercially available OS, as non-limiting examples. In some embodiments, the OS 122 can include a kernel, a process manager, memory manager, a file system, device drivers, and/or other types of services or components related to operating the at least one computer 102 (e.g., one or more user interfaces, a network stack and/or security-related services).

Generally, the one or more network interfaces 118 can be implemented as software, hardware, and/or firmware components, enabling the at least one computer 102 to communicate over the network 110 with the one or more databases 104, the at least one end user device 106, the one or more cloud computing environments 108, and/or other systems or devices not explicitly shown in FIG. 1. For example, the one or more network interfaces 118 can comprise one or more modems and/or one or more transceivers, such as a Wi-Fi transceiver.

The one or more buses 120 may be, for example, address, data, and/or control buses, and may include any interconnection mechanism, such as a series of lines on a motherboard or integrated circuit, fiber optics or other optical communication equipment, and/or other types of interconnection mechanisms.

The one or more databases 104 shown in FIG. 1 can be implemented using one or more storage systems. Such storage systems can include, for example, network-attached storage (NAS), storage area networks (SANs), direct-attached storage (DAS), and distributed DAS, and/or software-defined storage, as well as combinations of these and other storage types.

The at least one end user device 106 can be implemented in an equivalent manner as discussed above in conjunction with the at least one computer 102. In some embodiments, the at least one end user device 106 can be used by one or more end users, such as a customer or a user associated with an entity associated with at least one computer 102.

In some embodiments, the at least one end user device 106 can interact with at least one speech-enabled chatbot instance 124 that is executed at least in part by the at least one computer 102. For example, the speech-enabled chatbot instance 124 can communicate data to the at least one end user device 106 about one or more topics, as described in more detail elsewhere herein. The data communicated by the at least one speech-enabled chatbot instance 124 may correspond to a product and/or a service related to an organization, for example.

It is to be appreciated that in other embodiments, at least portions of the speech-enabled chatbot instance 124 can be executed locally by the at least end user device 106. As a non-limiting example, the speech-enabled chatbot instance 124 may utilize on-device processing capabilities (e.g., one or more CPUs, one or more GPUs, one or more ASICs, etc.) to perform at least a portion of functionalities described herein that are associated with the speech-enabled chatbot instance 124 (e.g., speech-to-text conversion, end-of-speech detection, response generation, and/or text-to-speech conversion).

In the example shown in FIG. 1, the network 110 is assumed to correspond to a wide area network (WAN), such as the Internet. Alternatively, or additionally, the network 110 can comprise a local area network (LAN), a satellite network, a telephone or cable network, a cellular network, a wireless network (e.g., a Wi-Fi or WiMAX network), or various portions or combinations of these and other types of networks. Generally, such networks implement hardware and/or components to enable data to be communicated, including, for example, cables, routers, firewalls, switches, gateways, and/or servers.

The one or more cloud computing environments 108 may include, for example, one or more public cloud computing environments, one or more private cloud computing environments, and/or one or more hybrid cloud computing environments. For example, a given cloud computing environment 108 can provide on-demand computing resources. Typically, the computing resources provided by a cloud computing environment are implemented using one or more virtualized computing environments.

A virtual computing environment can include physical hardware (e.g., one or more servers, one or more computers, and/or other types of computing devices) that implement one or more types of virtualized infrastructure, such as one or more virtual machines (VMs) and/or one or more containers. For example, a virtual computing environment may include software in the form of one or more hypervisors that manage one or more VMs running on the physical hardware. VMs generally refer to software representations of physical computers. VMs enable multiple OSs to run on a single physical host, where each VM can have its own set of virtual computing resources (e.g., CPU, memory, storage, and network resources).

Alternatively, or additionally, the virtual computing environment may include a plurality of containers implemented using one or more host devices. For examples containers can be stored as images that include the application code, dependencies, and configuration files that are used to run the container. A container runtime generally is used to manage the lifecycle of containers by creating, starting, stopping, and/or destroying containers. The container runtime also manages how resources are shared between such containers. An orchestration platform can be implemented to manage the deployment, scaling, and scheduling of containers. Containers are capable of running on any system regardless of the computing infrastructure and/or operating system.

It is to be understood that the particular set of elements shown in FIG. 1 is presented by way of illustrative example only, and in other embodiments additional or alternative elements may be used. Thus, another embodiment can include additional or alternative systems, devices and other network entities, as well as different arrangements of modules and other components. For example, in at least one embodiment, one or more of: the at least one computer 102, at least one of the databases 104, at least one of the cloud computing environments 108, and/or portions of such elements can be on and/or part of the same processing platform.

Having thus introduced one suitable but non-limiting technical context in which the exemplary embodiments described herein may be practiced, the exemplary embodiments will now be described with greater specificity.

Embodiments described herein introduce an intelligent method for detecting the end of user speech in speech-enabled chatbots. Unlike traditional VAD systems that rely on fixed timeouts, this method utilizes a faster, lightweight Large Language Model (LLM) to assess the context and content of the user’s speech in near real-time (around 50ms). By analyzing the last few messages, the system can determine with high accuracy whether the user has finished speaking, thereby eliminating unnecessary delays or interruptions and enhancing the conversational flow.

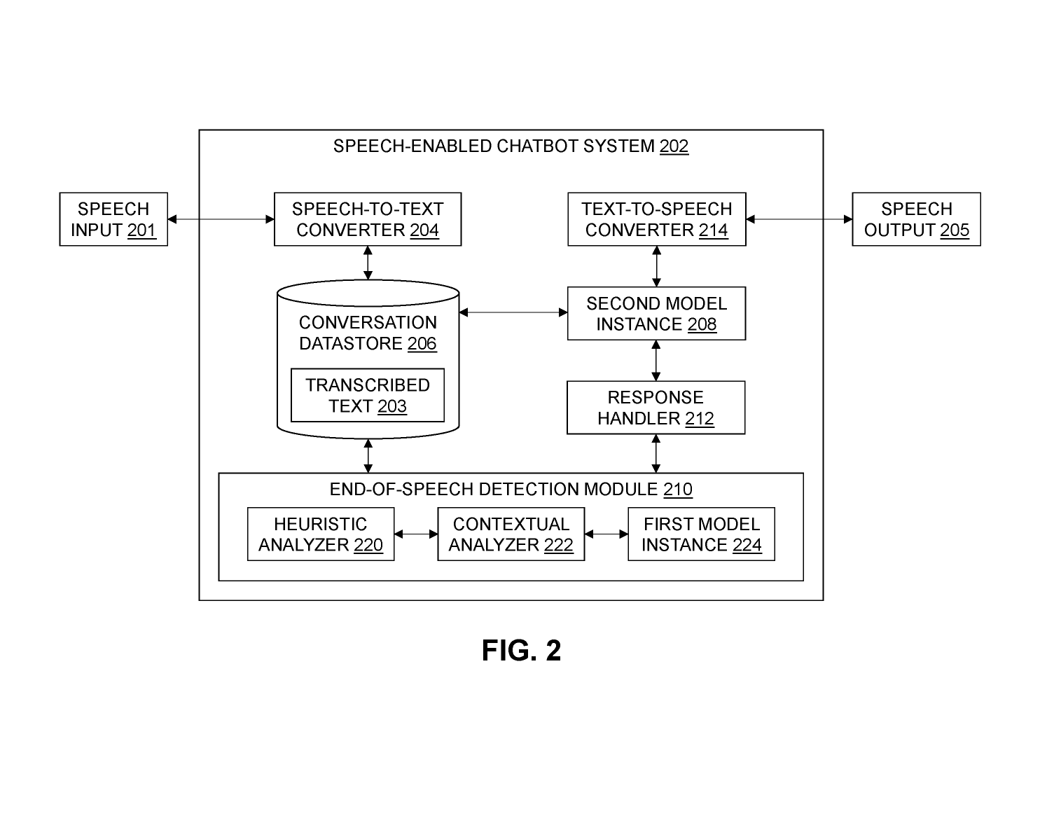

FIG. 2 shows a system architecture for a speech-enabled chatbot system 202 in accordance with an illustrative embodiment. In the example shown in FIG. 2, the speech-enabled chatbot system 202 includes a speech-to-text converter 204, a conversation datastore 206 and an end-of-speech detection module 210. The end-of-speech detection module 210 may include a heuristic analyzer 220, a contextual analyzer 222 and a first model instance 224. The speech-enabled chatbot system 202 also includes a second model instance 208, a response handler 212 and a text-to-speech converter 214.

It is noted that the term “instance” as used in the context of language models and elsewhere herein refers to a particular configuration for processing of at least one query and/or at least one task. In some examples, an instance of a given language model can include a specific input context provided by system messages, other message inputs, a selection of settings (e.g., selection of one or more hyperparameters such as temperature and/or top-p), and/or a particular model version. Generally, the temperature hyperparameter controls a randomness of a probability distribution of a next word being selected by the language model, where a higher temperature value results in more random and creative output and a lower temperature value results in more deterministic and conservative output. The top-p hyperparameter sets a threshold for the cumulative probability of words that are selected by the language model. For example, a higher top-p value allows a wider range of options that the model can select the next word from, and a lower top-p value limits the options to the most likely words. A given instance can operate within its designated context, serving at least one distinct function (e.g., evaluating whether a user has finished speaking and/or facilitating a conversation with a user).

The term “language model” in this context and elsewhere herein is intended to be broadly construed so as to encompass, for example, natural language processing models that are trained on massive amounts of data (e.g., possibly hundreds of gigabytes or more) to understand, summarize, generate and/or predict new content. Such language models are also commonly referred to as large language models. Language models often are implemented using transformer-based architectures. Transformer-based architectures can process input through a sequence of transformers, where each transformer includes a self-attention layer and feedforward layer. The self-attention layer computes an importance of each token in a sequence of input tokens, and the feedforward layer transforms the output of the self-attention layer into a form suitable for the next transformer in the sequence. It is noted that this is merely one example of a language model architecture, and other architectures can also be used, such as Long Short-Term Memory (LSTM) architectures.

In some embodiments, the second model instance 208 may be more complex than the first model instance 224. For example, the second model instance 208 may include more advanced features than the first model instance 224. Also, or alternatively, the second model instance 208 may have a larger number of model parameters and/or utilize more computing resources (e.g., processing, memory, and/or network). Thus, at least some embodiments can utilize the first model instance 224 to rapidly determine whether a user is finished speaking and generate coherent and accurate responses using the more complex second model instance 208. By way of example, the first model instance 224 may correspond to a lightweight LLM instance (e.g., approximately 70 billion or fewer parameters), while the second model instance 208 can correspond to a larger LLM instance (e.g., 400 billion or more parameters).

According to some embodiments, the elements shown in FIG. 2 can be implemented by the system in FIG. 1. As a non-limiting example, the speech-enabled chatbot system 202 can be implemented at least in part using the speech-enabled chatbot instance 124, the first model instance 224 and the second model instance 208 can be implemented by computer 102 and/or one or more of the cloud computing environments 108, and the conversation datastore 206 can be implemented by at least one of the databases 104. The speech-enabled chatbot system 202 can serve as the primary interaction point used by end users (e.g., associated with the at least one end user device 106) to provide speech input 201 (e.g., to initiate and participate in conversations), and to receive speech output 205 based on the speech input 201.

The speech-to-text converter 204 obtains the speech input 201 and converts the speech input 201 into text, which can be stored in the conversation datastore 206 as transcribed text 203. In some embodiments, the user can provide speech input 201 via one or more microphones, and the speech-to-text converter 204 can be configured to continuously listen and process the speech input 201 as it is provided.

The end-of-speech detection module 210 performs a heuristic analysis on the transcribed text 203 using its heuristic analyzer 220. In some embodiments, the heuristic analysis can include applying one or more rules to analyze the transcribed text 203 in substantially real time. For example, the rules can include checking for specific cues such as punctuation (e.g., question marks) and/or numerical patterns at the end of the transcribed text 203.

If the heuristic analysis is inconclusive (e.g., no cue or numerical pattern is detected), a contextual analysis is performed using the contextual analyzer 222 and the first model instance 224. In some embodiments, the contextual analyzer 222 can aggregate a specified number (e.g., four) of messages from a user’s conversation history. The contextual analyzer 222 constructs a prompt comprising the aggregated messages and sends the prompt to the first model instance 224.

The first model instance 224 is configured to process the prompt to predict whether the user has finished speaking and returns a first value (e.g., “done_talking”) or a second value (e.g., “not_done_talking”) based on the prediction.

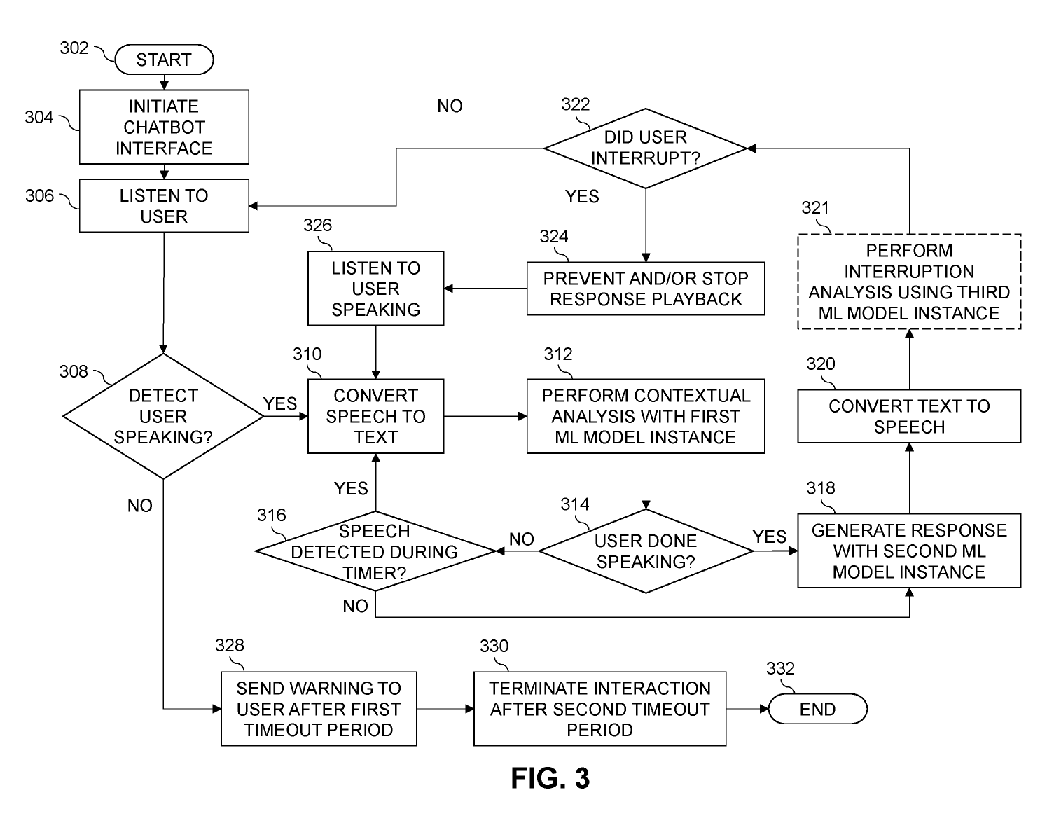

The response handler 212 obtains the output of the first model instance 224. If the output of the first model instance 224 indicates that the user is not done speaking, the response handler 212 initiates a timer for a configurable amount of time (e.g., four seconds) to allow the user time to continue speaking. In some embodiments, if no additional speech is detected, then the speech-enabled chatbot system 202 can provide a warning and/or terminate the conversation with the user, as explained in more detail in conjunction with FIG. 3, for example.

If the output of the first model instance 224 indicates that the user is done speaking, then the response handler 212 triggers the second model instance 208 to generate an appropriate response. The second model instance 208, when triggered by the response handler 212, generates the response based at least in part on the transcribed text 203 and/or previous messages in the user’s conversation history. For example, the second model instance 208 may correspond to a large language model that generates text by selecting one word (or token) at a time by calculating probabilities for each potential next word based on the input that the large language model has already processed and its internal parameters or weights. Words with higher probabilities are generally more likely to be chosen.

In some embodiments, the response generated by the second model instance 208 can also be stored in the conversation datastore 206 to improve the output of the first model instance 224 and/or the second model instance 208 when processing additional speech input 201, for example.

The response generated by the second model instance 208 is then converted into speech output using the text-to-speech converter 214. For example, the text-to-speech converter 214 can convert the generated response into an audio format for delivery to the user via the speech-enabled chatbot system 202.

It is to be understood that the particular set of elements shown in FIG. 2 is presented by way of illustrative example only, and in other embodiments alternative arrangements of the elements may be used. For example, in at least one embodiment, one or more of the elements 204-214 and/or portions of such elements can be on and/or part of two or more processing platforms. As a non-limiting example, the speech-to-text converter 204 and/or the text-to-speech converter 214 can be implemented using one or more cloud services, such as Amazon Transcribe and Amazon Polly®, respectively. Alternatively or additionally, the first model instance 224 and/or the second model instance 208 can be deployed in one or more cloud computing environments, where the speech-enabled chatbot system 202 communicates with the first model instance 224 and/or the second model instance 208 via one or more application programming interfaces (APIs).

In some embodiments, the first model instance 224 can comprise at least one autoregressive LLM that can be configured with a system prompt to detect whether the user is finished speaking. As an example, the system prompt can indicate the task to be completed by the machine learning model is to determine whether a user has finished speaking or is still formulating their thoughts in a speech-enabled conversation.

The system prompt can further include guidelines for making such a determination. As a non-limiting example, the guidelines can include one or more of the following: (i) a user is likely done talking if the user speech ends with a question mark or is phrased as a question; (ii) a user is likely not done talking if the user speech indicates the user is searching for information or needs more time (e.g., “hold on”, “let me find”, “give me a second”); (iii) the user is likely done talking if the user speech seems complete and doesn’t imply any continuation; and (iv) the user is likely not done talking if the user speech trails off or seems incomplete. In some embodiments, the system prompt can also include an instruction to output a specific set of values, such as binary values indicating whether or not the user is done speaking.

The system prompt can alternatively or additionally include one or more examples of user statements labeled with a desired response that should be output by the first model instance 224. For example, if the user statement is: “What's the weather like today?,” then the output of the first model instance 224 should indicate that the user is done talking.

FIG. 3 is an example of a process flow diagram for end-of-speech detection using multiple machine learning models in accordance with an illustrative embodiment. FIG. 3 can illustrate the operation of exemplary methods, the execution of computer program instructions embodied on computer-readable memory, the execution of functions performed by logic implemented in hardware, and/or interconnected means for performing functions in accordance with exemplary embodiments. In this embodiment, the process includes steps 302 through 332, which can be performed at least in part by the speech-enabled chatbot system 202 and/or the computer 102.

The process starts at step 302. Step 304 includes initiating a chatbot interface. For example, the chatbot interface can be implemented in response to a user request. In some embodiments, the chatbot interface can include sending a voice greeting message to the user.

Step 306 includes listening to the user. For example, a device associated with the user (e.g., end user device 106) can use one or more microphones to listen to the user’s speech and convert the speech into audio data. In some embodiments, the audio data can be streamed to the chatbot system (e.g., speech-enabled chatbot system 202).

Step 308 includes a test to detect whether the user is speaking. If the result of step 308 is yes, step 310 includes converting the speech to text. For example, the audio data can be processed to convert it into text data.

Step 312 includes performing a contextual analysis with a first machine learning (ML) model instance. In some embodiments, the contextual analysis can include generating a prompt for the first ML model instance, where the prompt includes the text resulting from step 310 and possibly one or more messages from the user’s recent conversation history. The first ML model instance processes the prompt and outputs a prediction of whether or not the user is finished speaking. In some embodiments, step 312 can also include performing a heuristic analysis as described above in conjunction with FIG. 2, for example.

Step 314 includes a test to determine if the user is done speaking. For example, the test can determine whether the user is done speaking based on the output of the first ML model instance from step 312. If the result of step 314 is no, then the process continues to step 316. Otherwise, the process continues to step 318.

Step 316 includes a test to check whether speech is detected during a designated time interval (e.g., in accordance with a timer). For example, the timer can be configured to allow additional time for the user to continue speaking. If speech is detected during this designated time interval, then the process returns to step 310 to convert the speech to text. Otherwise, the process continues to step 318.

Step 318 includes generating a response with a second ML model instance. For example, the second ML model instance can generate the response based on the text output at step 310 and/or one or more previous messages in the user’s conversation history. In this example, it is assumed that the response is generated in a text format.

Step 320 includes converting the text generated at step 318 to speech. For example, a text-to-speech converter can be used to convert the text into audio data, which is then streamed to the device associated with the user.

The process can optionally include step 321, which includes performing an interruption analysis using a third ML model instance. For example, when the user speaks while the chatbot is speaking, the third ML model instance can process the user’s speech to determine whether the speech constitutes an interruption. In some embodiments, the third ML model instance can receive the context of the conversation and the user’s most recent message as inputs, and then analyze these inputs to classify the user’s message as either interrupting or non-interrupting. In some embodiments, the third ML model instance can receive the entire context of the conversation as input. In other embodiments, the third ML model instance can receive a portion of the context, such as a designated number of tokens of the context.

In some embodiments, a system prompt can specify that the task of the third ML model instance is to determine whether a user’s message in a conversation interrupts the flow of dialogue or is merely a confirmation phrase. The system prompt can also provide examples of phrases that are considered interrupting and/or non-interrupting. Non-limiting examples of non-interrupting phrases that can be included in the system prompt can include short confirmation phrases (e.g. “no problem”, “no worries”, “uh”, “oh”, “right”, etc.) and/or attention-seeking phrases (e.g., “hello?”, “is anyone there?”, etc.). Non-limiting examples of interrupting phrases that can be included in the system prompt can include intentional interruptions or answers (e.g., “yes”, “that one”, “no”, “the email is”, “where can I”, “tell me more about”, “what?”, “huh?”, etc.) and/or interjections of information (e.g., “order status”, a phone number, a physical address, an email address, etc.). In at least one embodiment, the third ML model instance can use the same model and/or API host as the first ML model instance that is used for the contextual analysis in step 312. However, in such embodiments, the third ML model instance is assumed to have an independent context and system prompt.

Step 322 includes a test to check whether the user interrupted (e.g., while the response is being played back to the user). If the result of step 322 is yes, then the process continues to step 324, which includes preventing and/or stopping the playback of the response. In some embodiments, the result of the test can be based at least in part on the interruption analysis performed at step 321. For example, output of the third ML model instance is “interrupting,” then the result of step 322 can be yes, and if the output of the third ML model instance is “non-interrupting”, then the result of step 322 can be no.

Step 326 includes listening to the user following the interruption, and then the process returns to step 310 to process the speech following the interruption. If the result of step 322 is no (indicating that the user did not interrupt during the playback of the response), then the process returns to step 306.

If the result of step 308 is no, then the process continues to step 328. Step 328 includes sending a warning to the user after a first timeout period (e.g., ten seconds). For example, the warning can ask the user, “are you still there?” If the user does not respond, then step 330 includes terminating the interaction after a second timeout period (e.g., sixty seconds). Alternatively, the process can end in response to a user input. The process ends at step 332.

It is to be understood that the process depicted in FIG. 3 is only an example, and additional or alternative processes can be carried out in other embodiments.

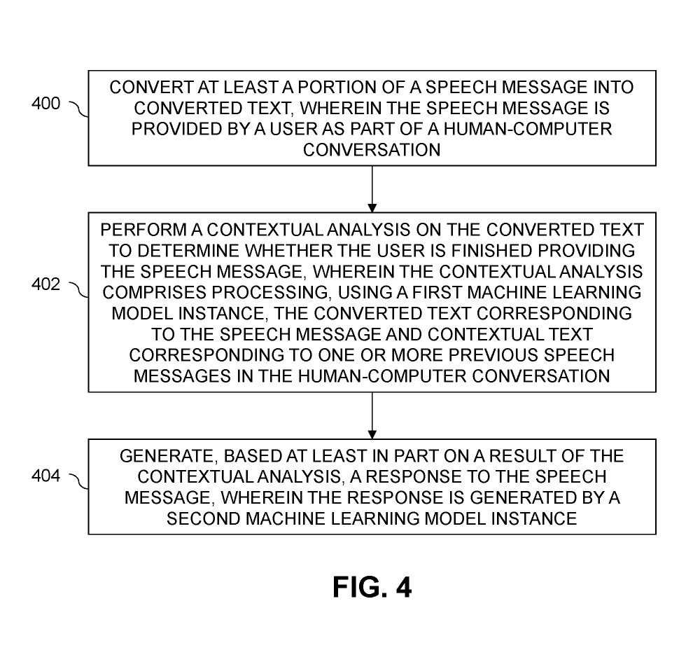

FIG. 4 is a logic flow diagram of a process for end-of-speech detection for chatbot interactions according to an illustrative embodiment. It is to be understood that this particular process is only an example, and additional or alternative processes can be carried out in other embodiments.

Step 400 includes converting at least a portion of a speech message into converted text, wherein the speech message is provided by a user as part of a human-computer conversation.

Step 402 includes performing a contextual analysis on the converted text to determine whether the user is finished providing the speech message, wherein the contextual analysis comprises processing, using a first machine learning model instance, the converted text corresponding to the speech message and contextual text corresponding to one or more previous speech messages in the human-computer conversation.

Step 404 includes generating, based at least in part on a result of the contextual analysis, a response to the speech message, wherein the response is generated by a second machine learning model instance.

The process can further include, in response to the converting, performing a heuristic analysis on the converted text to determine whether the user is finished providing the speech message based at least in part on a set of rules applied to the converted text.

The contextual analysis may be performed based at least in part on a result of the heuristic analysis.

The one or more rules may correspond to one or more numerical patterns at the end of the converted text and/or one or more punctuation marks at the end of the converted text.

The first machine learning model instance may output a binary value indicative of whether the user is finished providing the speech message.

The process may further include, in response to the first machine learning model instance predicting that the user is not finished providing the speech message, initiating a configurable timer to allow additional time for the user to continue speaking.

Generating the response may include converting the response generated by the second machine learning model instance into a speech format.

In some embodiments, the process may further include causing the response to be output to the user in the speech format, and performing an interruption analysis using a third machine learning model instance while the response is being generated by the second and/or being output to the user in the speech format. The third machine learning model instance may be configured to process additional text corresponding to an additional speech message provided by the user to classify whether or not the additional message is an interruption based at least in part on the contextual text and the converted text.

The first machine learning model instance and the second machine learning model instance may correspond to different machine learning models.

A number of parameters of the second machine learning model instance may be greater than a number of parameters of the first machine learning model instance. The second machine learning model instance and the first machine learning model instance may have a different set of capabilities. The second machine learning model instance may utilize more computing resources than the first machine learning model instance.

The first machine learning model instance may be configured to predict whether the user is finished providing the speech message within one or more real-time constraints.

Without in any way limiting the scope, interpretation, or application of the claims appearing below, a technical effect of one or more of the example embodiments disclosed herein is a chatbot system that utilizes an intelligent end-of-speech detection mechanism that utilizes a lightweight ML model to assess whether a user is finished speaking in near real-time. Another technical effect of one or more of the example embodiments disclosed herein is reducing unnecessary delays or premature terminations during user interactions, thereby enhancing the responsiveness and accuracy of human-computer conversations. Such embodiments can effectively overcome at least some disadvantages of conventional chatbot systems, which often rely on fixed timeouts to determine when a user has finished speaking, leading to suboptimal user experiences due to either excessive waiting times or unintentional interruptions.

Embodiments herein may be implemented in software (executed by one or more processors), hardware (e.g., an ASIC), or a combination of software and hardware. In an example embodiment, the code (e.g., software code and/or an instruction set) is maintained on any one of various computer-readable media. In the context of this document, a “computer-readable medium” may be any media or means that can contain, store, communicate, propagate or transport the instructions for use by or in connection with an instruction execution system, apparatus, or device, such as the non-limiting example of the computer 102 described and depicted in FIG. 1. A computer-readable medium may comprise a computer-readable storage medium (e.g., memories 114, storage 116 or another device) that may be any media or means that can contain, store, and/or transport the software for use by or in connection with an apparatus, or device, such as a computer. Articles of manufacture comprising such computer-readable or processor-readable storage media are considered embodiments of the invention. A given such article of manufactures may comprise, for example, a storage device such as a storage disk, a storage array or an integrated circuit containing memory. It should be understood that such articles of manufacturer exclude transitory, propagating signals.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A computer-implemented method comprising:
converting at least a portion of a speech message into converted text, wherein the speech message is provided by a user as part of a human-computer conversation;
performing a contextual analysis on the converted text to determine whether the user is finished providing the speech message, wherein the contextual analysis comprises processing, using a first machine learning model instance, the converted text corresponding to the speech message and contextual text corresponding to one or more previous speech messages in the human-computer conversation; and
generating, based at least in part on a result of the contextual analysis, a response to the speech message, wherein the response is generated by a second machine learning model instance;
wherein the method is performed by at least one processing device comprising a processor coupled to a memory.

2. The computer-implemented method of claim 1, further comprising:
in response to the converting, performing a heuristic analysis on the converted text to determine whether the user is finished providing the speech message based at least in part on a set of rules applied to the converted text.

3. The computer-implemented method of claim 2, wherein the contextual analysis is performed based at least in part on a result of the heuristic analysis.

4. The computer-implemented method of claim 2, wherein the one or more rules correspond to at least one of:
one or more numerical patterns at the end of the converted text; and
one or more punctuation marks at the end of the converted text.

5. The computer-implemented method of claim 1, wherein the first machine learning model instance outputs a binary value indicative of whether the user is finished providing the speech message.

6. The computer-implemented method of claim 1, further comprising:
in response to the first machine learning model instance predicting that the user is not finished providing the speech message, initiating a configurable timer to allow additional time for the user to continue speaking.

7. The computer-implemented method of claim 1, wherein the generating the response comprises:
converting the response generated by the second machine learning model instance into a speech format.

8. The computer-implemented method of claim 1, wherein the first machine learning model instance and the second machine learning model instance correspond to different machine learning models.

9. The computer-implemented method of claim 1, wherein at least one of:
a number of parameters of the second machine learning model instance is greater than a number of parameters of the first machine learning model instance;
the second machine learning model instance and the first machine learning model instance have a different set of capabilities; and
the second machine learning model instance utilizes more computing resources than the first machine learning model instance.

10. The computer-implemented method of claim 1, wherein the first machine learning model instance is configured to predict whether the user is finished providing the speech message within one or more real-time constraints.

11. A non-transitory processor-readable storage medium having stored therein program code of one or more software programs, wherein the program code when executed by at least one processing device causes the at least one processing device to:
convert at least a portion of a speech message into converted text, wherein the speech message is provided by a user as part of a human-computer conversation;
perform a contextual analysis on the converted text to determine whether the user is finished providing the speech message, wherein the contextual analysis comprises processing, using a first machine learning model instance, the converted text corresponding to the speech message and contextual text corresponding to one or more previous speech messages in the human-computer conversation; and
generate, based at least in part on a result of the contextual analysis, a response to the speech message, wherein the response is generated by a second machine learning model instance.

12. The non-transitory processor-readable storage medium of claim 11, wherein the program code when executed by the at least one processing device further causes the at least one processing device to:
in response to the converting, perform a heuristic analysis on the converted text to determine whether the user is finished providing the speech message based at least in part on a set of rules applied to the converted text.

13. The non-transitory processor-readable storage medium of claim 12, wherein the contextual analysis is performed based at least in part on a result of the heuristic analysis.

14. The non-transitory processor-readable storage medium of claim 12, wherein the one or more rules correspond to at least one of:
one or more numerical patterns at the end of the converted text; and
one or more punctuation marks at the end of the converted text.

15. The non-transitory processor-readable storage medium of claim 11, wherein the first machine learning model instance outputs a binary value indicative of whether the user is finished providing the speech message.

16. An apparatus comprising:
at least one processing device comprising a processor coupled to a memory;
the at least one processing device being configured:
to convert at least a portion of a speech message into converted text, wherein the speech message is provided by a user as part of a human-computer conversation;
to perform a contextual analysis on the converted text to determine whether the user is finished providing the speech message, wherein the contextual analysis comprises processing, using a first machine learning model instance, the converted text corresponding to the speech message and contextual text corresponding to one or more previous speech messages in the human-computer conversation; and
to generate, based at least in part on a result of the contextual analysis, a response to the speech message, wherein the response is generated by a second machine learning model instance.

17. The apparatus of claim 16, wherein the at least one processing device is further configured:
in response to the converting, to perform a heuristic analysis on the converted text to determine whether the user is finished providing the speech message based at least in part on a set of rules applied to the converted text.

18. The apparatus of claim 17, wherein the contextual analysis is performed based at least in part on a result of the heuristic analysis.

19. The apparatus of claim 17, wherein the one or more rules correspond to at least one of:
one or more numerical patterns at the end of the converted text; and
one or more punctuation marks at the end of the converted text.

20. The apparatus of claim 16, wherein the first machine learning model instance outputs a binary value indicative of whether the user is finished providing the speech message.
